(19) United States
(12) Patent Application Publication
(10) Pub. No.: US 2016/0225285 A1
(43) Pub. Date: Aug. 4, 2016

(54) Spanish Language Teaching Systems and Methods

(71) Applicant: Joel Lane Mayon, Rowlett, TX (US)

(72) Inventor: Joel Lane Mayon, Rowlett, TX (US)

(21) Appl. No.: 14/214,469

(22) Filed: Mar. 14, 2014

Related U.S. Application Data
(60) Provisional application No. 61/789,820, filed on Mar. 15, 2013.

(51) Int. Cl. G09B 19/06; G09B 5/02; G09B 19/08

(52) U.S. Cl. CPC G09B 19/06; G09B 19/08; G09B 5/02

(57) ABSTRACT

Spanish language teaching systems and methods include a method, a computing device, and printed materials that perform the steps of receiving a word in Spanish; categorizing the word in one of four word sets including word set A, word set B, word set C, and word set D; responsive to categorizing the word in the one of the four word sets, determining which syllable of the word is stressed; and, responsive to determining which syllable of the word is stressed, determining whether the word receives an accent mark and a proper placement of the accent mark.

This document comprises the non provisional patent application and claims benefit of the filing date of Mar. 15, 2013 of the provisional patent application No. 61/789,820 with the title “SPANISH LANGUAGE TEACHING SYSTEMS AND METHODS.”

### DETAILED DESCRIPTION OF THE DISCLOSURE

In various exemplary embodiments, the present disclosure includes Spanish language teaching systems and methods that enable users to determine correct pronunciation, where to include accents, which syllable to stress, and the like. The Spanish language teaching systems and methods can be a computer or mobile device application, a paper-based system, or the like.

The following terminology is used in the foregoing descriptions and terms in italic are terms defined in the glossary itself:

Atonic Syllable: Every word has at least one atonic syllable. The atonic syllable or atonic syllables in any word include every syllable/s in the word that is not the tonic syllable;

Consecutive Nucleic Processing: Words of same word type being consecutively processed in a predetermined and ordered way through word-set processing means. This predetermined and ordered way means that every possible combinatory potential of every nucleus (vocalic content) of each word (that is part of the consecutive nucleic processing) is processed through the word-set processing means until user interacts with all possible combinatory potentials of salient syllables of the words of the same word type. For example if the content of the significant syllable is a single vowel, then one word after another word (of the same word type) that includes a single vowel in the significant syllable is processed through the word-set processor until all 5 vowels are processed through the word-set processor. Casa, gente, cita, gota, gusta are all words of the same word type as a function of the content of the significant syllable being a single vowel. Casa has an “a,” gente has an “e,” cita has an “i,” gota has an “o,” and gusta has a “u” in the significant syllable. Since there are only five single vowels in Spanish, the user interacts with every possible type of nucleus of that specific word type which is A2;

Control Function: Any operation that facilitates input to implicit knowledge processing;

Identified Significant Syllable: Significant syllable identified as a result of any marked word or unmarked word (output) having been processed through the significant-syllable-identifier processing;

Implicit Knowledge: Knowledge of how to use any or all of the salient features in order to be able to correctly place accent marks on words in Spanish. Knowledge of how to use any or all of the salient features in order to convert input to output in Spanish. Knowledge of how to use any or all of the salient features [within the word-set control function] in order to be able to correctly convert input into a marked word or to be able to correctly convert any word into an unmarked word;

Input: Any word before it has been processed through the word-set processing. Structured input is a subset of input;

Letter: A vowel or consonant in Spanish;

Marked Word: Any word or (input) or (structured input) that has been converted into output from having been processed through the word-set processing and determined to have an acute written accent mark placed on the marked word. A word with an acute accent mark written over nucleus of the significant syllable of the word;

Output: Input that has been processed through the word-set processing and so has been converted from input to output. As a function of the processing and the conversion, the word becomes output. The output is a word that has been processed through the word-set processing and therefore converted into either a marked word or an unmarked word. Output is either a marked word or an unmarked word;

Pretonic Syllable: The syllable that immediately precedes the tonic syllable;

Posttonic Syllable: The syllable that immediately follows the tonic syllable;

Processing Means (two ways): As raw input is converted to input; and as input is converted to structured input; and as structured input is converted to output, there are two means (distinct types) of processing that can occur:

1) software program locates, fetches, displays and makes available for processing by user any pertinent data (i.e. raw input, input, output). This data is preprocessed and stored in the preprocessed database. This data will be available for access by user and used by user to process words through the means for word-set processing.

2) software program processes this data (via algorithms) in the form of raw input into input and/or structured input and makes data available to user for processing through the means for word-set processing. In this manner of software processing, the data isn't preprocessed or stored in a database, but rather the software processes the data input as user enters the raw input and/or any other pertinent input into the input mechanism.

Salient Features of Input: The features in input that are processed and are necessary for word-set processing and for the conversion of input to implicit knowledge. The features of input are not only alphabetic and features related to tonic or atonic syllables, but include noticing, recognition and processing on the part of the user:
1) final letter in word;
2) the spotlit syllable of word—as a function of the final letter in the word;
3) the significant syllable of word;
4) whether word is marked with an accent mark or whether said word is not marked with an accent mark—as a function of (5);
5) whether the spotlit syllable and the significant syllable are the same syllable=unmarked words or whether the spotlit syllable and the significant syllable are not the same syllable=marked words;
6) that the spotlit syllable of word is a function of the whether the final letter of word is a consonant excluding an “n” or an “s” or whether said final letter is a vowel, an “n” or an “s”;
7) the pretonic syllable of word, its alphabetic content and pretonic syllable's interrelationship with significant syllable;
8) the posttonic syllable of word, its alphabetic content and posttonic syllable's interrelationship with significant syllable;
9) that the spotlit syllable of every word is either the last syllable or the penultimate syllable;
10) that the significant syllable of any word that ends in a consonant (except n or s) is either the final syllable or the penultimate syllable;
11) that the significant syllable of every word ending in an “n,” an “s” or a vowel is one of the last four syllables of each word;
12) the alphabetic content of the significant syllable and the position of significant syllable with respect to the position of the pretonic syllable and the posttonic syllable and any potential interrelationship of the features in (12);
13) the alphabetic content of the pretonic syllable and the position of pretonic syllable with respect to the position of the significant syllable and any potential interrelationship of the features in (13);
14) the alphabetic content of the posttonic syllable and the position of posttonic syllable with respect to the postion of the significant syllable and any potential interrelationship of the features in (14);
15) that the significant syllable can be focused upon visually and aurally;
16) Single Vowel in the significant syllable;
17) Diphthongs in the significant syllable. Adjacency of upper and lower vowel within one syllable. A monosyllabic speech-sound sequence perceived as being made up of two differing vowel qualities, as the pronunciation of nación;
18) Río-type words. Hiatus between tonic upper vowel attached to one or a multiple of preceding consonants constituting the tonic syllable and atonic lower vowel such that even though the two vowels (upper and lower vowels as found in a monosyllabic diphthong) are adjacent to each other, hiatus exists such that the combination of the tonic upper vowel with the atonic lower vowel causes the two phonemes to be pronounced in two syllables;
19) Leía-type words. Even though the atonic lower vowel/tonic upper vowel/atonic lower vowel appear adjacently to each other, there is hiatus because of the tonic upper vowel falling between the two outer atonic adjacent lower vowels e and a. So there is no triphthong or no diphthong;
20) Ruidoso-type words. Two adjacent upper vowels are pronounced as a diphthong in one syllable;
21) Triphthong. Phonetics. A monosyllabic speech-sound sequence perceived as being made up of three differing vowel qualities, as the pronunciation of dioico;
22) Leo-type words. Two consectutive lower vowels results in two syllables; and
23) that word-set features exist and said word-set features' contituent parts can be found in input.

Significant Syllable: The tonic syllable of a word;

Significant-Syllable-Identifier Features: These are the identical features as the word-set feature;

Significant-Syllable-Identifier Control Function: Any operation that effectuates significant-syllable-identifier processing of at least one or any multiple of the significant-syllable-identifier features (either singularly or any multiple of significant-syllable-identifier features in conjunction with any other multiple of significant-syllable-identifier features);

Significant-Syllable-Identifier Processing: Interaction of any marked word (output) or any unmarked word (output) in conjunction with significant-syllable-identifier features of said marked word or unmarked word (output) that converts said marked word or said unmarked word (output)to identified significant syllable; Significant-Syllable-Identifier processing a word through ABCD processing means is running any marked word or unmarked word (output)through the ABCD yes/no algorighms in reverse. This is easy to capture if you go through the algorithm from right to left -starting with is the word marked or not marked? yes/no then depending on yes/no—does the word end in a consonant or does the word end in a vowel, n or s will disclose the stressed syllable.

Spotlit Syllable: Syllable onto which focus is placed as a function of the final letter of any word. Said spotlit syllable is the penultimate syllable if the word ends in a vowel, an “n” or an “s”. The spotlit syllable is the final syllable if the word ends in a consonant that is not an “n” or an “s”;

Structured Input: Input that has been classified into a particular word type. This classification is a function of the alphabetical content of the word's significant syllable or the content of the word's pretonic syllable and posttonic syllable as applicable; other criteria that serve as criteria for classifying word types are the relative position of the significant syllable with regard to the word's pretonic syllable and the word's posttonic syllable. Structured Input is a subset of input in that said structured input is input that has been processed through the word-classifying processing;

Tonic Syllable: Every word has one tonic syllable. The syllable in a word that is the vocally-stressed syllable;

Unmarked Word: Any word or (input) or (structured input) that has been converted into output from having been processed through the word-set processing and determined not to have a written acute accent mark placed over nucleus of significant syllable of the unmarked word. A word without an acute accent mark written over nucleus of significant syllable of the word. After having been processed through the word-set processing, every word in Spanish is either an unmarked word or a marked word in that said word either has a written accent mark as in esta or doesn't have a written accent mark as in casa;

Word: Any word that can be spelled correctly in Spanish before being processed through the word-set processing. For the word to be spelled correctly, it is necessary for the word to be converted into either a marked word or an unmarked word. After having been processed through the word-set processing, every word will be converted into correctly-spelled output. Any word that has not been processed through the word-set processing is neither a marked word nor an unmarked word;

Word Set Features (Criteria):

| Word Set A | Word Set B | Word Set C | Word Set D |
|---|---|---|---|
| Unmarked | Marked | Unmarked | Marked |
| Words | Words | Words | Words |
| Ends in Vowel, | Ends in Vowel, | Ends in | Ends in |
| n, or s | n, or s | Consonant yes | Consonant yes |
| yes | yes | | |
| Stress on | Stress Not on | Stress on Last | Stress not on |
| Penultimate | Penultimate | Syllable | Last Syllable |
| Syllable | Syllable | yes | no |
| yes | no | | |
| Yes/Yes | Yes/No | Yes/Yes | Yes/No |
| Spotlit Syllable | Spotlit Syllable | Spotlit Syllable | Spotlit Syllable |
| is the | is Penultimate | is the Last | is the Last |
| Penultimate | Syllable as | Syllable as | Syllable as |
| Syllable as a | a function | a function of | a function of |
| function of | of Word | Word Ending | Word Ending |
| Word Ending | Ending | | |

Word-sets A, B, C, D are the four basic word sets. Distinguishing Criteria per word set for each of the four word sets is: 1. Word ending and 2. Whether spotlit syllable is the tonic syllable or whether spotlit syllable is not the tonic syllable;

Word-set Control Function: Any operation that effectuates word-set processing of at least one or any multiple of the following salient features (either singularly or any multiple of salient features in conjuntion with any other multiple of salient features;

Word Set Features: Features that distinguish unmarked words from marked words. There are two types of word-set features: 1) The final letter of any word. These features are word-final, alphabetic features that distinguish every word into either one of two alphabetic categories. The two alphabetic categories are: words that end in a vowel, an “n” or an “s” and words that end in a consonant that is not an “n” or an “s.” Each of the alphabetic categories are divided into two distinct categories as a function of: 2) whether the spotlit syllable is the same syllable as the tonic syllable or whether the spotlit syllable and the tonic syllable are distinct syllables. Therefore, word-set features are the criteria used to determine the four basic word sets ABCD into which every word in Spanish can be categorized. The fact that there are four distinct basic word set categories is a function of the fact that there exists two types of word set features and two alphabetic categories exist within each type of the word set feature;

Word Group: Every word in the Spanish language can be categorized into a distinct word type and placed into a group of words of the same word type. So every word in the Spanish language can be categorized into a distinct word group. So every other word in the Spanish language of the same word type can be categorized and placed into a distinct word group of words all of the same word type;

Word-Set Processing: Interaction of input and/or structured input in conjunction with salient features of the input and/or salient features of the structured input that facilitates (increases the likelihood of) conversion of input to implicit knowledge. After input or structured input has been processed through the word-set processing processing algorithms described herein. Word-set processing a word through ABCD processing is running the word through the ABCD yes/no algorithms. Either type input (input or structured input) can be run through these algorithms. The principle idea of the invention is to practice (process) a multiple of the same word types through the ABCD yes/no algorithms (called (ABCE) Word-set processing means). The content used for processing a word using the word-set processing means is the word-set features. The content used for word-type processing using the same word types is the combinatory potential of distinct types of letters (vowels or multiple types and consonants) found in the significant syllable or the pretonic syllable or the posttonic syllable;

Word Type: A manner of categorizing every word in Spanish. Every word is categorized into one word type as distinguished from a multiple of word types as a function of the alphabetical content of said word's significant syllable or the alphabetical content of said word's pretonic syllable (when applicable) and the alphabetical content of said word's posttonic syllable (when applicable). Other criteria that serve as criteria for categorizing word types are the relative position of the significant syllable with regard to said word's pretonic syllable (when applicable)and the position of the significant syllable with regard to said word's posttonic syllable (when applicable). Every word in Spanish can be categorized into a particular word type. The combinatory potential of the content of every word type is at least one of the following types of letters: 1) Single Vowel in the significant syllable; 2) Diphthongs in the significant syllable. Adjacency of upper and lower vowel within one syllable. A monosyllabic speech-sound sequence perceived as being made up of two differing vowel qualities, as the pronunciation of nación; 3) Río-type words. Hiatus between tonic upper vowel attached to one or a multiple of preceeding consonants constituting the tonic syllable and atonic lower vowel such that even though the two vowels (upper and lower vowels as found in a monosyllabic diphthong) are adjacent to each other, hiatus exists such that the combination of the tonic upper vowel with the atonic lower vowel causes the two phonemes to be pronounced in two syllables; 4) Leía-type words. Even though the atonic lower vowel/tonic upper vowel/atonic lower vowel appear adjacently to each other, there is hiatus because of the tonic upper vowel falling between the two outer atonic adjacent lower vowels e and a. So there is no triphthong or no diphthong; 5) Ruidoso-type words. Two adjacent upper vowels are pronounced as a diphthong in one syllable; 6) Triphthong. Phonetics. A monosyllabic speech-sound sequence perceived as being made up of three differing vowel qualities, as the pronunciation of dioico; and 7) Leo-type words. Two consectutive lower vowels results in two syllables. Every word type is more generally categorized into one and only one of the word type's distinct word set so that a multiple of word types are categorized into each one of the four basic word sets.

Word-Type Features A multiple of types of alphabetic content of a word's significant syllable or a multiple of types of alphabetic content of a word's significant syllable in combination with a multiple of types of alphabetic content of said word's pretonic syllable or a multiple of types of alphabetic content of a word's significant syllable in combination with a multiple of types of alphabetic content of said word's posttonic syllable. The pretonic syllable, tonic syllable (significant syllable) and the postonic syllable are the foundation for converting words (input) into (structured input) words belonging to a multiple of word types.

Referring to FIG. 1, in an exemplary embodiment, a flowchart illustrates a word-set processing method 100. The word-set processing method 100 can be implemented on a computer, a mobile-device, via paper or other printed material, or the like. The word-set processing method 100 includes the ABCD yes/no algorithms described herein. Word-sets A, B, C, D are the four basic word sets. Distinguishing Criteria per word set for each of the four word sets is: 1. Word ending and 2. Whether spotlit syllable is the tonic syllable or whether spotlit syllable is not the tonic syllable. The word-set processing method 100 receives a word (step 102). In the context of a computing device, the step 102 can include inputting the word into the device via text, talk-to-text, etc. In the context of printed materials, the step 102 can include writing the word down on paper, a white board, etc. The word-set processing method 100 includes checking if the word ends in a vowel, n, or s or in a consonant (step 104). Every word in Spanish falls into one of two categories: 1) ends in a vowel, an “n” or an “s” or 2) ends in a consonant that is not an “n” or an “s”.

If the word ends in a vowel, an “n” or an “s” (step 104), the word-set processing method 100 checks if the stress is on the penultimate syllable (step 106). If the stress is on the penultimate syllable (step 106), the word receives no mark (step 108) and the word is categorized in the word set A. If the stress is not on the penultimate syllable (step 106), the word receives a mark over a vowel of the stressed syllable (step 110) and the word is categorized in the word set B. If the word ends in a consonant that is not an “n” or an “s” (step 104), the word-set processing method 100 checks if the stress is on the last syllable (step 112). If the stress is on the last syllable (step 112), the word receives no mark (step 114) and the word is categorized in the word set C. If the stress is not on the last syllable (step 112), the word receives a mark over the vowel of the stressed syllable (step 116) and the word is categorized in the word set D. Word Sets A and C are not marked (do not get accent marks). And Word Sets A and B are marked (do get accent marks). Every word in Spanish is categorized into only one distinct word set.

Referring to FIGS. 2 and 3, in an exemplary embodiment, a block diagram illustrates an exemplary implementation of a server 200 and a client device 300 which may be utilized in the systems and methods described herein. The server 200 and the client device 300 may each be a digital computer that, in terms of hardware architecture, generally includes a processor 202, 302, input/output (I/O) interfaces 204, 304, a network interface 206 for the server 200, a radio 306 for the client device 300, a data store 208, 308, and memory 210, 310. It should be appreciated by those of ordinary skill in the art that FIGS. 2 and 3 depict the server 200 and the client device 300 in an oversimplified manner, and a practical embodiment may include additional components and suitably configured processing logic to support known or conventional operating features that are not described in detail herein. The components (202, 204, 206, 208, 210, 302, 304, 306, 308, 310) are communicatively coupled via a local interface 212, 312. The local interface 212, 312 may be, for example but not limited to, one or more buses or other wired or wireless connections, as is known in the art. The local interface 212, 312 may have additional elements, which are omitted for simplicity, such as controllers, buffers (caches), drivers, repeaters, and receivers, among many others, to enable communications. Further, the local interface 212, 312 may include address, control, and/or data connections to enable appropriate communications among the aforementioned components.

The processor 202, 302 is a hardware device for executing software instructions. The processor 202, 302 may be any custom made or commercially available processor, a central processing unit (CPU), an auxiliary processor among several processors associated with the server 200 and the client device 300, a semiconductor-based microprocessor (in the form of a microchip or chip set), or generally any device for executing software instructions. When the server 200 and the client device 300 is in operation, the processor 202, 302 is configured to execute software stored within the memory 210, 310, to communicate data to and from the memory 210, 310, and to generally control operations of the server 200 and the client device 300 pursuant to the software instructions. Note, the processor 310 may include a mobile-optimized architecture whereas the processor 210 may include a server-optimized architecture. The I/O interfaces 204, 304 may be used to receive user input from and/or for providing system output to one or more devices or components. User input may be provided via, for example, a keyboard, touch pad, stylus, voice commands, and/or a mouse. System output may be provided via a display device, audible indicia, and a printer (not shown). I/O interfaces 204, 304 can include, for example, a serial port, a parallel port, a small computer system interface (SCSI), an infrared (IR) interface, a radio frequency (RF) interface, a universal serial bus (USB) interface, and/or any proprietary interfaces (e.g. 19 pin or 30 pin connectors). The I/O interfaces 204, 304 can include a graphical user interface (GUI) that enable user interaction. Furthermore, the I/O interfaces 204, 304 may include a camera and/or video camera device.

The network interface 206 may be used to enable the server 200 to communicate on a network, such as the Internet and the like, etc. For example, the server 200 can utilize the network interface 206 to communicate to/from the plurality of users 102, etc. The network interface 206 may include, for example, an Ethernet card or adapter (e.g., 10 BaseT, Fast Ethernet, Gigabit Ethernet) or a wireless local area network (WLAN) card or adapter (e.g., 802.11a/b/g/n). The network interface 206 may include address, control, and/or data connections to enable appropriate communications on the network. The radio 306 enables wireless communication for the client device 300. Any number of suitable wireless data communication protocols, techniques, or methodologies can be supported by the radio 306, including, without limitation: RF; IrDA (infrared); Bluetooth; ZigBee (and other variants of the IEEE 802.15 protocol); IEEE 802.11 (any variation) or other WLAN variant; IEEE 802.16 (WiMAX or any other variation); any 3G/4G Long Term Evolution (LTE) related protocols; paging network protocols; magnetic induction; satellite data communication protocols; GPRS; Global Positioning Satellite (GPS); and any other wireless data communication protocols. For example, the radio 306 can have multiple functions such as, without limitation, communication via a wireless service provider using 3G/4G, communication via a WLAN, and location determination via GPS.

The data store 208, 308 may be used to store data. The data store 208, 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208, 308 may incorporate electronic, magnetic, optical, and/or other types of storage media. In one example, the data store 208 may be located internal to the server 200 such as, for example, an internal hard drive connected to the local interface 212 in the server 200. Additionally in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network attached file server. In the context of the client device 300, the data store 308 is typically local to the device although the client device 300 can also access external data stores in a manner similar to the server 200.

The memory 210, 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210, 310 may incorporate electronic, magnetic, optical, and/or other types of storage media. Note that the memory 210, 310 may have a distributed architecture, where various components are situated remotely from one another, but can be accessed by the processor 202, 302. The software in memory 210, 310 may include one or more software programs, each of which includes an ordered listing of executable instructions for implementing logical functions. The software in the memory 210, 310 includes a suitable operating system (O/S) 214, 314 and one or more programs 216, 316. The operating system 214, 314 essentially controls the execution of other computer programs, such as the one or more programs 216, 316, and provides scheduling, input-output control, file and data management, memory management, and communication control and related services. The programs 216, 316 can include an application operating the method 100. For example, the server 200 can be a Web portal or the like operating the method 100. The client device 300 can have a local app that operates the method 100, and optionally can be communicatively coupled to the server 200.

Referring to FIGS. 4A and 4B, in an exemplary embodiment, a screen shot and a flow diagram illustrate an exemplary operation of the method 100 with the words “arbol” and “beisbol.” In FIG. 4A, a screen shot shows an exemplary application operating the method 100 on either the server 200 or the client device 300. In FIG. 4B, the proper marking of the words is illustrated in an operation of the method 100. For example, “arbol” ends in a consonant and does not stress the last syllable thus is marked “arbol” The word “beisbol” ends in a consonant and does not stress the last syllable thus is marked “béisbol.” Both “arbol” and “beisbol” are members of word set D. Furthermore, “arbol” is categorized further into word group 6 being a member of word type 6, and “beisbol” is categorized further into word group 12 being a member of word type 12.

Referring to FIGS. 5A and 5B, in an exemplary embodiment, a screen shot and a flow diagram illustrate an exemplary operation of the method 100 with the words “nacion” and “comi.” In FIG. 5A, a screen shot shows an exemplary application operating the method 100 on either the server 200 or the client device 300. In FIG. 5B, the proper marking of the words is illustrated in an operation of the method 100. For example, “nacion” ends in a vowel, “n”, or “s” and does not stress the penultimate syllable thus is marked “nación.” The word “comi” ends in a vowel, “n”, or “s” and does not stress the penultimate syllable thus is marked “comí.” Both “comi” and “nacion” are members of word set B. Furthermore, “comi” is categorized further into word group 1 being a member of word type 1, and “nacion” is categorized further into word group 7 being a member of word type 7.

Referring to FIGS. 6A and 6B, in an exemplary embodiment, a screen shot and a flow diagram illustrate an exemplary operation of the method 100 with the words “semana” and “miento.” In FIG. 6A, a screen shot shows an exemplary application operating the method 100 on either the server 200 or the client device 300. In FIG. 6B, the proper marking of the words is illustrated in an operation of the method 100. For example, “semana” ends in a vowel, “n”, or “s” and does stress the penultimate syllable thus is not marked “semana.” The word “miento” ends in a vowel, “n”, or “s” and does stress the penultimate syllable thus is not marked “miento.” Both “semana” and “miento” are members of word set A. Furthermore, “semana” is categorized further into word group 2 being a member of word type 2, and “miento” is categorized further into word group 8 being a member of word type 8.

Referring to FIGS. 7A and 7B, in an exemplary embodiment, a screen shot and a flow diagram illustrate an exemplary operation of the method 100 with the words “verdad” and “cambiar.” In FIG. 7A, a screen shot shows an exemplary application operating the method 100 on either the server 200 or the client device 300. In FIG. 7B, the proper marking of the words is illustrated in an operation of the method 100. For example, “verdad” ends in a consonant and does stress the last syllable thus is not marked “verdad.” The word “cambiar” ends in a consonant and does stress the last syllable thus is not marked “cambiar.” Both “verdad” and “cambiar” are members of word set C. Furthermore, “verdad” is categorized further into word group 5 being a member of word type 5, and “socicdad” is categorized further into word group 21 being a member of word type 21. A key function of this invention regard the interrelationship between word sets and word types. Both word sets and word types are a classification method for categorizing words in Spanish so that the words can be processed in a way that teaches the user how to internalize the proficiency required to enable the user to mark accent marks on words in Spanish in an accurate way.

In an exemplary aspect of the present disclosure, every word in the Spanish language can be categorized into a distinct word type and placed into a group of words of the same word type. So every word in the Spanish language can be categorized into a distinct word group. So every other word in the Spanish language of the same word type can be categorized and placed into a distinct word group of words all of the same word type. For example, there can be 23 word groups. These word groups are different from the word sets A, B, C, D, but can be a useful tool to students and users for understanding how to attach accent marks. That is, the present disclosure can present similar words to users from the words input into the method 100 to facilitate learning. By establishing 23 word groups, a student studying words in one group at a time, advancing systematically from one group to another through all 23 groups, advantageously learns the practice of accurate accent marking A resident dictionary or listing can be included that resolves any ambiguities in the mind of the student with regard to which syllable is stressed in any word delivered audibly or displayed. The established 23 word groups further assist in resolving any ambiguities in the mind of the student with regard to which syllable is stressed in any word delivered audibly or display. There are 23 word types distributed through the word sets A, B, C, D. The word types are nominally designated simply as WT (“Word Type”) 1-23. The basic word types are nominally designated as A, B, C and D. The criteria for the 23 word types are distinct from that of the 4 basic word categories ABCD. Herein type is synonymous with group.

The 23 word types are described as follows:

### Word Type 1

Significant Syllable: The Word's Only Stressed Syllable (pronunciation)
One Significant Syllable per Word.
Word-Type 1 List of Criteria:
1) Significant Syllable: Ultimate
2) Word ends in: Vowel, n or s
3) Significant Features in Significant Syllable: Single Vowel
4) Vowel/s type in Significant Syllable: Contains Any One Vowel see examples

Examples: hablé, se cortó, corrí
5) Word Marked
Word Type 2
Significant Syllable: The Word's Only Stressed Syllable (pronunciation)
One Significant Syllable per Word.
Word-Type 2 List of Criteria:
1) Significant Syllable: PenUltimate
2) Word ends in: Vowel, n or s
3) Significant Features in Significant Syllable: Single Vowel
4) Vowel/s type in Significant Syllable: Contains Any One Vowel see examples

Examples: imposible casa bimbo
5) Word Not Marked

### Word Type 3

Significant Syllable: The Word's Only Stressed Syllable (pronunciation)
One Significant Syllable per Word.
Word-Type 3 List of Criteria:
1) Significant Syllable: AntePenUltimate
2) Word ends in: Vowel, n or s
3) Significant Features in Significant Syllable: Single Vowel
4) Vowel/s type in Significant Syllable: Contains Any One Vowel see examples

Examples: último, átomo, mínimo
5) Word Marked

### Word Type 4

Significant Syllable: The Word's Only Stressed Syllable (pronunciation)
One Significant Syllable per Word.
Word-Type 4 List of Criteria:
1) Significant Syllable: TransAntePenUltimate
2) Word ends in: Vowel, n or s
3) Significant Features in Significant Syllable: Single Vowel
4) Vowel/s type in Significant Syllable: Contains Any One Vowel see examples

Examples: contestándoselo, consúltamelo, cómetelo
5) Word Marked

### Word Type 5

Significant Syllable: The Word's Only Stressed Syllable (pronunciation)
One Significant Syllable per Word.
Word-Type 5 List of Criteria:
1) Significant Syllable: Ultimate
2) Word ends in: Consonant
3) Significant Features in Significant Syllable: Single Vowel
4) Vowel/s type in Significant Syllable: Contains Any One Vowel see examples

Examples: universidad, profesor, comedor
5) Word Not Marked

### Word Type 6

Significant Syllable: The Word's Only Stressed Syllable (pronunciation)
One Significant Syllable per Word.
Word-Type 6 List of Criteria:
1) Significant Syllable: PenUltimate
2) Word ends in: Consonant
3) Significant Features in Significant Syllable: Single Vowel
4) Vowel/s type in Significant Syllable: Contains Any One Vowel see examples

Examples: dólar, árbol, lápiz
5) Word Marked

### Word Type 7

Significant Syllable: The Word's Only Stressed Syllable (pronunciation)
One Significant Syllable per Word.
Word-Type 8 List of Criteria:
1) Significant Syllable: Ultimate
2) Word ends in: Vowel, n or s
3) Significant Features in Significant Syllable: Diphthong
4) Vowel/s type in Significant Syllable: Contains Upper and Lower see examples

Examples: comió, nación, también
5) Word Marked

### Word Type 8

Significant Syllable: The Word's Only Stressed Syllable (pronunciation)
One Significant Syllable per Word.
Word-Type 8 List of Criteria:
1) Significant Syllable: PenUltimate
2) Word ends in: Vowel, n or s
3) Significant Features in Significant Syllable: Diphthong
4) Vowel/s type in Significant Syllable: Contains Upper and Lower see examples

Examples: peino, miento, suelo
5) Word Not Marked

### Word Type 9

Significant Syllable: The Word's Only Stressed Syllable (pronunciation)
One Significant Syllable per Word.
Word-Type 9 List of Criteria:
1) Significant Syllable: AntePenUltimate
2) Word ends in: Vowel, n or s
3) Significant Features in Significant Syllable: Diphthong
4) Vowel/s type in Significant Syllable: Contains Upper and Lowersee examples

Examples: huérfano, diáfono
5) Word Marked

### Word Type 10

Significant Syllable: The Word's Only Stressed Syllable (pronunciation)
One Significant Syllable per Word.
Word-Type 10 List of Criteria:
1) Significant Syllable: TransAntePenUltimate
2) Word ends in: Vowel, n or s
3) Significant Features in Significant Syllable: Diphthong
4) Vowel/s type in Significant Syllable: Contains Upper and Lowersee examples

Examples: sirviéndoselo, péinatelo, pruébatelo, uniéndoselo, ciérramelo
5) Word Marked

### Word Type 11

Significant Syllable: The Word's Only Stressed Syllable (pronunciation)
One Significant Syllable per Word.
Word-Type 11 List of Criteria:
1) Significant Syllable: Ultimate
2) Word ends in: Consonant
3) Significant Features in Significant Syllable: Diphthong
4) Vowel/s type in Significant Syllable: Contains Upper and Lower see examples

Examples: cambiar, menospreciar
5) Word Not Marked

### Word Type 12

Significant Syllable: The Word's Only Stressed Syllable (pronunciation)
One Significant Syllable per Word.
Word-Type 12 List of Criteria:
1) Significant Syllable: PenUltimate
2) Word ends in: Consonant
3) Significant Features in Significant Syllable: Diphthong
4) Vowel/s type in Significant Syllable: Contains Upper and Lower see examples

Examples: Suárez, tráiler, béisbol,
5) Word Marked

### Word Type 13

Significant Syllable: The Word's Only Stressed Syllable (pronunciation)
One Significant Syllable per Word.
Secondary Significant Syllable Content: Subsequent Syllable to Significant Syllable
Consisting of One Lower Vowel
Word-Type 13 List of Criteria:
1) Significant Syllable: PenUltimate
2) Word ends in: Vowel,n,s
3) Significant Features in Significant Syllable: Significant Syllable consists of a single upper vowel preceded by a consonant and followed by a lower vowel in subsequent syllable=hiatus
4) Vowel/s type in Significant Syllable: Contains Stressed Upper Vowel=Syllable Limit

Examples: río, María, comía, fluí, construí
5) Word Marked
Word Type 14
Significant Syllable: The Word's Only Stressed Syllable (pronunciation)
One Significant Syllable per Word.
Word-Type 14 List of Criteria:
1) Significant Syllable: AntePenUltimate
2) Word ends in: Vowel,n,s
3) Significant Features in Significant Syllable: Significant Syllable consists of a single upper vowel preceded by a consonant and followed by a lower vowel in subsequent syllable=hiatus
4) Vowel/s type in Significant Syllable: Contains Stressed Upper Vowel=Syllable Limit see examples

Examples: comíamos, escribíamos, servíamos
5) Word Marked Hiatus

### Word Type 15

Significant Syllable: The Word's Only Stressed Syllable (pronunciation)
One Significant Syllable per Word.
Secondary Significant Syllable Content: Second-lower vowel of the two-lower-vowel sequence
Word-Type 15 List of Criteria:
1) Significant Syllable: PenUltimate
2) Word ends in: Vowel,n,s
3) Significant Features in Significant Syllable: First lower vowel of a two-lower-vowel sequence constituting two syllables.
4) Vowel/s type in Significant Syllable: Contains see examples

Examples: mercadeo, leo, cree, crea,
5) Word Not Marked

### Word Type 16

Significant Syllable: The Word's Only Stressed Syllable (pronunciation)
One Significant Syllable per Word.
Secondary Significant Syllable Content: First-lower vowel of the two-lower-vowel sequence
Word-Type 16 List of Criteria:
1) Significant Syllable: PenUltimate
2) Word ends in: vowel,n,s
3) Significant Features in Significant Syllable: Second lower vowel of a two-lower-vowel sequence constituting two syllables.
4) Vowel/s type in Significant Syllable: Contains see examples

Examples: oceano,
5) Word Gets Accent Mark?

### Word Type 17

Significant Syllable: The Word's Only Stressed Syllable (pronunciation)
One Significant Syllable per Word.
Secondary Significant Syllable Content: First-lower vowel of the two-lower-vowel sequence
Word-Type 17 List of Criteria:
1) Significant Syllable: AntePenUltimate
2) Word ends in: vowel,n,s
3) Significant Features in Significant Syllable: Second lower vowel of a two-lower-vowel sequence constituting two syllables.
4) Vowel/s type in Significant Syllable: Contains see examples

Examples: meódromo, teórico, aéreo, poético
5) Word Gets Accent Mark?

### Word Type 18

Significant Syllable: The Word's Only Stressed Syllable (pronunciation)
One Significant Syllable per Word.
Word-Type 19 List of Criteria:
1) Significant Syllable: PenUltimate
2) Word ends in: Vowel,n,s
3) Significant Features in Significant Syllable: Syllable consists of A Single Upper Vowel. This Single Upper Vowel is followed directly by a lower vowel in subsequent syllable. Hiatus.
4) Vowel/s type in Significant Syllable: Contains see examples

Examples: leía, caía, fluído, constuído
5) Word Marked

### Word Type 20

Significant Syllable: The Word's Only Stressed Syllable (pronunciation)
One Significant Syllable per Word.
Word-Type 20 List of Criteria:
1) Significant Syllable: Ultimate
2) Word ends in: Consonant
3) Significant Features in Significant Syllable: Significant Syllable consists of a single upper vowel followed by a consonant. This single upper vowel is preceded by a lower vowel in the preceding syllable=hiatus
4) Vowel/s type in Significant Syllable: Contains Any One Vowel see examples
Examples: Raúl
5) Word Marked

### Word Type 21

Significant Syllable: The Word's Only Stressed Syllable (pronunciation)
One Significant Syllable per Word.
Secondary Significant Syllable Content: SSS Syllable has Unstressed Diphthong
Word-Type 21 List of Criteria:
1) Significant Syllable: Ultimate
2) Word ends in: Consonant
3) Significant Features in Significant Syllable: Single Vowel
4) Vowel/s type in Significant Syllable: Contains Upper and Lowersee examples

Examples: Sociedad, propiedad
5) Word Not Marked

### Word Type 22

Significant Syllable: The Word's Only Stressed Syllable (pronunciation)
One Significant Syllable per Word.
Secondary Significant Syllable Content:
Word-Type 22 List of Criteria:
1) Significant Syllable: PenUltimate
2) Word ends in: Vowel,n,s
3) Significant Features in Significant Syllable: Upper-Vowel Diphthong
4) Vowel/s type in Significant Syllable: Contains Two Upper Vowels see examples

Examples: diurno, viuda, incluido, fluido,
5) Word Not Marked

### Word Type 23

Significant Syllable: The Word's Only Stressed Syllable (pronunciation)
One Significant Syllable per Word.
Secondary Significant Syllable Content:
Word-Type 23 List of Criteria:
1) Significant Syllable: AntePenUltimate
2) Word ends in: Vowel,n,s Hiatus?
3) Significant Features in Significant Syllable: Upper-VowelDiphthong
4) Vowel/s type in Significant Syllable: Contains Two Upper Vowels see examples

Examples: jesuítico
5) Word Not Marked

The word types and example words are categorized as follows:

| Basic Word | Word | Word | Word |
|---|---|---|---|
| Types A | Types B | Types C | Types D |
| WT 2 casa | WT 1 hablé | WT 5 universidad | *WT 20 Raúl |
| WT 8 miento | WT 3 último | WT 11 cambiar | WT 6 dólar |
| WT 15 leo | WT 4 cómetelo | WT 21 sociedad | WT 12 béisbol |
| WT 16 oceano | WT 7 nación | | *Special Word |
| WT 18 Mario | WT 9 huérfano | | Type that |
| WT 22 viuda | WT 10 pruébatelo | | contains a |
| | WT 13 río | | stressed upper |
| | WT 14 comíamos | | vowel in the |
| | WT 17 poético | | last syllable. |
| | WT 19 leía | | |
| | WT 23 jesuítico | | |

Table 1 details the 4 basic word types ABCD

Words are further typed under the 23 word types. For example:
A2—Refers to words in basic word type A, type 2;
B1—Refers to words in basic word type B, type 1;
C5—Refers to words in basic word type C, type 5; and
D6—Refers to words in basic word type D, type 6.
   The content of the Significant Syllable is of the same type in all four of these word types. Review the content of the Significant Syllable of each of these word types, and you will find that the content of the significant syllable of each word type is that it has a single vowel in said Significant Syllable.

What happens when user enters a word

Enter A Word—

I. Information Stored in Database of Invention

A. Potentially all words in Spanish can be stored in database in preprocessed form (since all words can be preprocessed and stored as follows) in this invention:

1. word is syllabified

2. word's (tonic) significant syllable identified

3. word's pretonic syllable identified—syllable that precedes tonic syllable (if word has pretonic syllable)

4. word's posttonic syllable identified—syllable that succeeds the tonic syllable (if word has a posttonic syllable)

5. placed into a specific word group as a function of word types. Every word of the same word type will be categorized into the same word group

6. then word gets processed through word-set processing (the processing means for converting structured input to implicit knowledge) for any word that is a member of word set A, word set B, word set C, or word set D—or to be processed through any other pertinent processing means. or

B. Means of processing entered word (potentially all word in Spanish) automatically via algorithms. Algorithms process word automatically—in real time when entered—accordingly:

1. word is syllabified

2. word's (tonic) significant syllable identified

3. word's pretonic syllable identified—syllable that precedes tonic syllable (if word has pretonic syllable)

4. word's posttonic syllable identified—syllable that succeeds the tonic syllable (if word has a posttonic syllable)

5. placed into a specific word group as a function of word types. Every word of the same word type will be categorized into the same word group

6. then word gets processed through word-set processing (the processing means for converting structured input to implicit knowledge) for any word that is a member of word set A, word set B, word set C, or word set D—or to be processed through any other pertinent processing means.

C. Means of Finding Word, Fetching Word, Displaying Word for Word-Set Processing by user.

Since it is not known by user whether an entered word is an unmarked word or a marked word (in other words whether the entered word is spelled correctly), it is necessary to provide a processing means (algorithms) for locating, fetching and displaying the processed form of the entered unprocessed word. In the context of this paragraph, processed means the word is categorized into word's appropriate word set ABCD and/or into word's word group as a function of word's word type. It also means the word will be syllabified, have its significant syllable identified as well as the word's pretonicsyllable identified as applicable and the word's posttonic syllable identified as applicable and highlighted as appropriate and its final letter highlighted.

Patent covers:

All of the processes above can be performed (carried out via algorithms as word is entered) automatically by

(1) a processing means (algorithms) for processes listed above (1. word syllabified, 2. word's (tonic) significant syllable identified, 3. word's pretonic syllable identified—4. word's posttonic syllable identified-syllable 5. placed into a specific word group as a function of word types, 6. then word gets processed through word-set processing—the processing means for converting structured input to implicit knowledge—) for any word that is a member of word set A, word set B, word set C, or word set D—or to be processed through any other pertinent processing means.

In this case, the algorithms that perform the processes above are stored in the database. Or

(2) all of the above processes (1-6 above) are stored in database from having been preprocessed and stored into database so that all of these processes (1. syllabified word, 2. significant-syllable-identified word, 3. pretonic syllable identified, 4. posttonic syllable identified, and 5. word categorized into a word group as a function of the entered word's word type, and 6. word categorized into a word set ABC or D) can be located, fetched, and displayed for word-set processing. In this case the preprocessed words are store in database from having been preprocessed as listed above.

The illustration (FIG. 1) can be used to show how a word is processed by the software (app) into Word Set A, Word Set B, Word Set C, Word Set D before it is received into word-set processing.

After the word is processed into its appropriate word set, then user starts to run word through the word-set processing means to determine if word is a marked word or an unmarked word. User learns how to convert input into implicit knowledge by running the word through the word-set processor.

Besides being categorized into the appropriate word set, the word is also syllabified, significant syllable identified (and highlighted) and its final letter highlighted so the user can accurately process the word through word set processing.

Then FIGS. 4B, 5B, 6B, 7B can also be used to illustrate word set processing for the four Word Sets as you already have in the Detailed Description. Each of these slides has two distinct Word Types being processed simultaneously (per the same Word Set) showing the distinct features within each word's significant syllable.

Each pair of words in these examples are similar in that within the significant syllable of each word one word has a single vowel in its significant syllable while the other word has a diphthong in its significant syllable.

When a word is received for the user to process through the word-set processing means, that word has already had the salient features identified and highlighted at the appropriate time for each step (as it is processed) as can be viewed on the displayed algorithms in the word-set processor.

That word has already:

1) been syllabified

2) final letter highlighted

3) significant syllable identified

There are two ways that the word gets to the user in this condition:

1) words are stored that way in the database on the server

2) a separate algorithm performs these processes as the word is entered.

The reason the significant-syllable identifier is necessary is to teach the user how to identify the significant syllable starting from output (either a marked word or an unmarked word) and going through the word-set processor in reverse. If user starts with a marked word—he can easily see the significant syllable, it is the one that is marked. If user starts with an unmarked word—he will go in reverse through the word-set processor which will inform user as to which syllable is the significant syllable. Example se ma na Does word en in a vowel,n,s=yes. Is word unmarked=yes. Then the significant syllable is the penultimate syllable. Same is true for unmarked words ending in consonants that are not an n or s.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the claims herein.

### FIELD OF THE DISCLOSURE

The present disclosure relates generally to language teaching systems and methods. More particularly, the present disclosure relates to Spanish language teaching systems and methods that enable users to determine correct pronunciation, where to include accents, which syllable to stress, and the like.

### BACKGROUND OF THE DISCLOSURE

Learning languages from birth involves the process of immersion in the language and picking it up as you go along. In particular with Spanish, in order to learn the orthography used when writing in Spanish, it is necessary to learn to place acute accent marks over vowels in words in Spanish. Conventionally, learning to correctly place the written accent marks on words continues to be a problem and generally involves learning rules. It is assumed that these rules are applied in a very similar way to all words in Spanish. As long as the rules have existed, there has been and continues to be a need for improvement in which learners learn to place said accent marks over words in Spanish. Disadvantageously, conventional learning techniques require a considerable amount of time and effort to learn. What is needed is a novel system and method to process words that allows and forces the user to focus on salient features as the user interacts with the salient features.

### BRIEF SUMMARY OF THE DISCLOSURE

In an exemplary embodiment, a method includes receiving a word in Spanish; categorizing the word in one of four word sets including word set A, word set B, word set C, and word set D; responsive to categorizing the word in the one of the four word sets, determining which syllable of the word is stressed; and responsive to determining which syllable of the word is stressed, determining whether the word receives an accent mark and a proper placement of the accent mark. The method can be implemented by a computer or in implemented in printed materials. The categorizing step can include assigning the word to the word set A or the word set B when the word ends in a vowel, “n”, or “s;” and assigning the word to the word set C or the word set D when the word ends in a consonant not including “n” or “s.” The determining which syllable of the word is stressed can include, when the word is in the word set A or the word set B, determining whether stress is on a penultimate syllable of the word; and, when the word is in the word set C or the word set D, determining whether the stress is on the last syllable. The method can further include, when the word is in the word set A or the word set B, performing the steps of: determining the word is in the word set A when the stress is on the penultimate syllable and placing no accent mark on the word; and determining the word is in the word set B when the stress is not on the penultimate syllable and placing an accent mark on the word over a vowel of a stressed syllable; and, when the word is in the word set C or the word set D, performing the steps of: determining the word is in the word set C when the stress is on the last syllable and placing no accent mark on the word; and determining the word is in the word set D when the stress is not on the last syllable and placing an accent mark on the word over a vowel of stressed syllable. The method can further include categorizing the word in one of 23 word types; and presenting similar words in the one of the 23 word types.

In another exemplary embodiment, a computing device includes input and output mechanisms; a processor communicatively coupled to the input and output mechanisms; and memory storing instructions that, when executed, cause the processor to perform the steps of: receiving a word in Spanish; categorizing the word in one of four word sets including word set A, word set B, word set C, and word set D; responsive to categorizing the word in the one of the four word sets, determining which syllable of the word is stressed; and, responsive to determining which syllable of the word is stressed, determining whether the word receives an accent mark and a proper placement of the accent mark. The instructions, when executed, can further cause the processor to perform the steps of: assigning the word to the word set A or the word set B when the word ends in a vowel, “n”, or “s;” and assigning the word to the word set C or the word set D when the word ends in a consonant not including “n” or “s.” The instructions, when executed, can further cause the processor to perform the steps of: when the word is in the word set A or the word set B, determining whether stress is on a penultimate syllable of the word; and, when the word is in the word set C or the word set D, determining whether the stress is on the last syllable. The instructions, when executed, can further cause the processor to perform the steps of: when the word is in the word set A or the word set B, performing the steps of: determining the word is in the word set A when the stress is on the penultimate syllable and placing no accent mark on the word; and determining the word is in the word set B when the stress is not on the penultimate syllable and placing an accent mark on the word over a vowel of a stressed syllable; and, when the word is in the word set C or the word set D, performing the steps of: determining the word is in the word set C when the stress is on the last syllable and placing no accent mark on the word; and determining the word is in the word set D when the stress is not on the last syllable and placing an accent mark on the word over a vowel of stressed syllable. The instructions, when executed, can further cause the processor to perform the steps of: categorizing the word in one of 23 word types; and presenting similar words in the one of the 23 word types.

In yet another exemplary embodiment, Printed materials include instructions a user to perform the steps of providing a word in Spanish; categorizing the word in one of four word sets including word set A, word set B, word set C, and word set D; responsive to categorizing the word in the one of the four word sets, determining which syllable of the word is stressed; and, responsive to determining which syllable of the word is stressed, determining whether the word receives an accent mark and a proper placement of the accent mark. The printed materials can further include instructions to cause the user to perform the steps of: assigning the word to the word set A or the word set B when the word ends in a vowel, “n”, or “s;” and assigning the word to the word set C or the word set D when the word ends in a consonant not including “n” or “s.” The printed materials can further include instructions to cause the user to perform the steps of: when the word is in the word set A or the word set B, determining whether stress is on a penultimate syllable of the word; and, when the word is in the word set C or the word set D, determining whether the stress is on the last syllable. The printed materials can further include instructions to cause the user to perform the steps of: when the word is in the word set A or the word set B, performing the steps of: determining the word is in the word set A when the stress is on the penultimate syllable and placing no accent mark on the word; and determining the word is in the word set B when the stress is not on the penultimate syllable and placing an accent mark on the word over a vowel of a stressed syllable; and, when the word is in the word set C or the word set D, performing the steps of: determining the word is in the word set C when the stress is on the last syllable and placing no accent mark on the word; and determining the word is in the word set D when the stress is not on the last syllable and placing an accent mark on the word over a vowel of stressed syllable. The printed materials can further include instructions to cause the user to perform the steps of: categorizing the word in one of 23 word types; and presenting similar words in the one of the 23 word types.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a flowchart of a word-set processing method;

FIG. 2 is a block diagram of an exemplary implementation of a server which may be utilized in the systems and methods described herein;

FIG. 3 is a block diagram of an exemplary implementation of a client device which may be utilized in the systems and methods described herein;

FIGS. 4A and 4B are a screen shot and a flow diagram of an exemplary operation of the method of FIG. 1 with the words “arbol” and “beisbol;”

FIGS. 5A and 5B are a screen shot and a flow diagram of an exemplary operation of the method of FIG. 1 with the words “nacion” and “comi;”

FIGS. 6A and 6B are a screen shot and a flow diagram of an exemplary operation of the method of FIG. 1 with the words “semana” and “miento;” and

FIGS. 7A and 7B are a screen shot and a flow diagram of an exemplary operation of the method of FIG. 1 with the words “verdad” and “cambiar.”

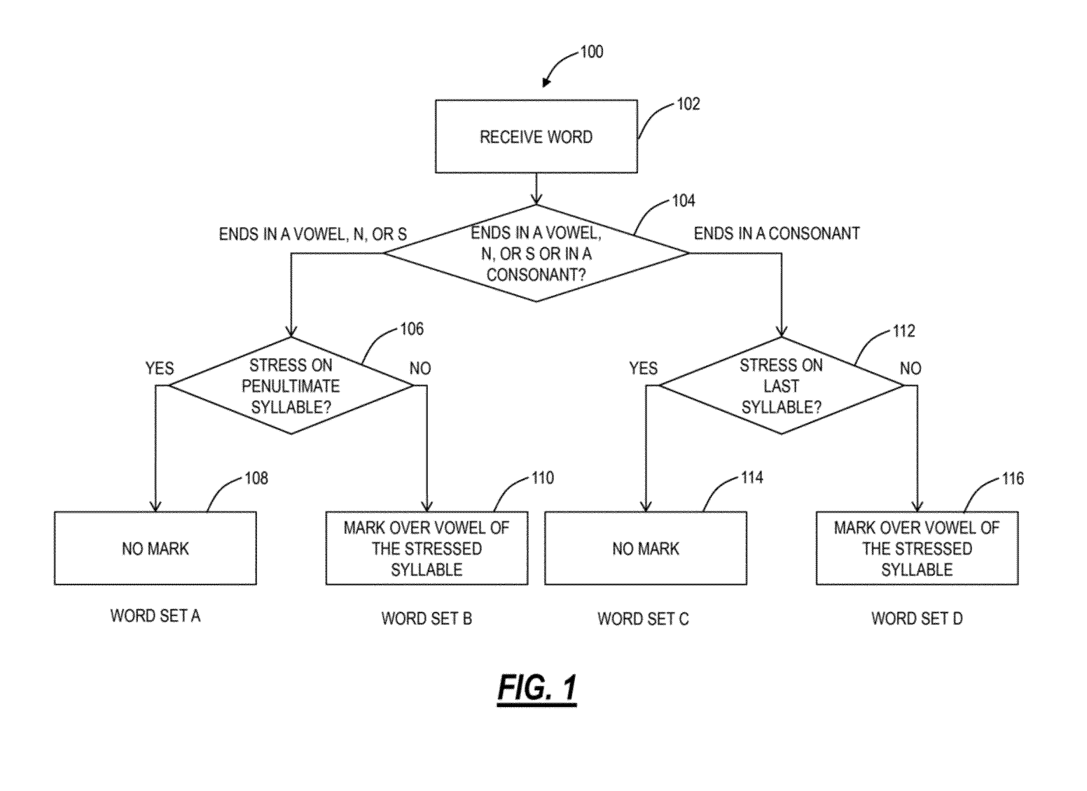

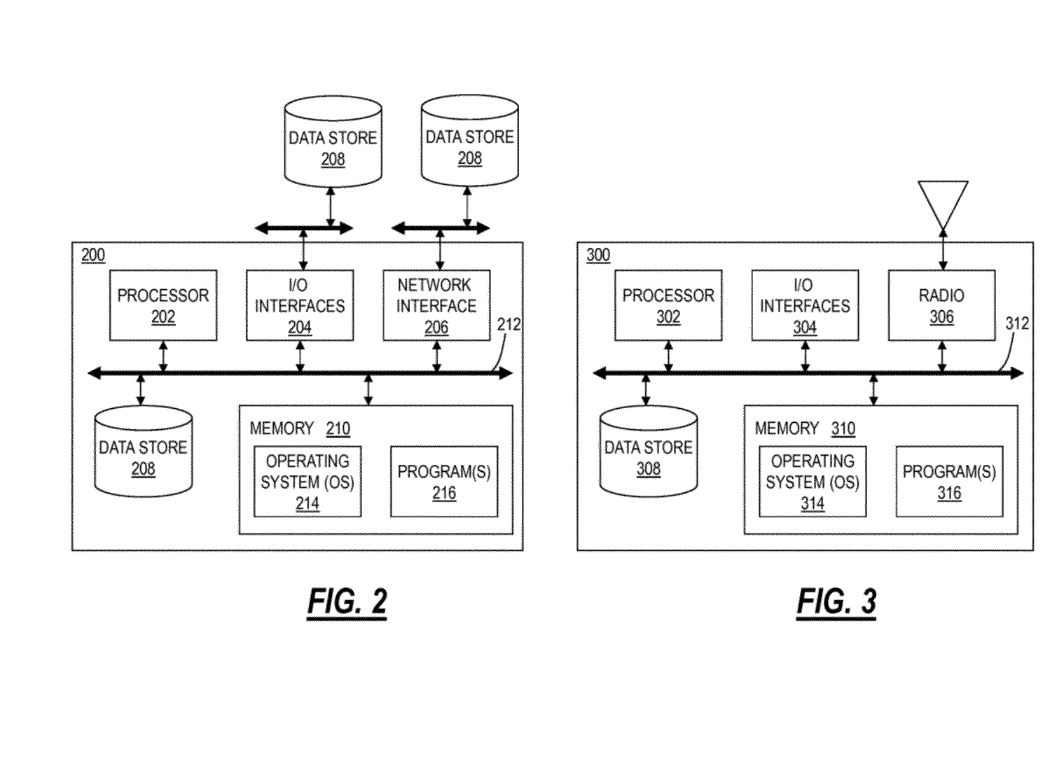

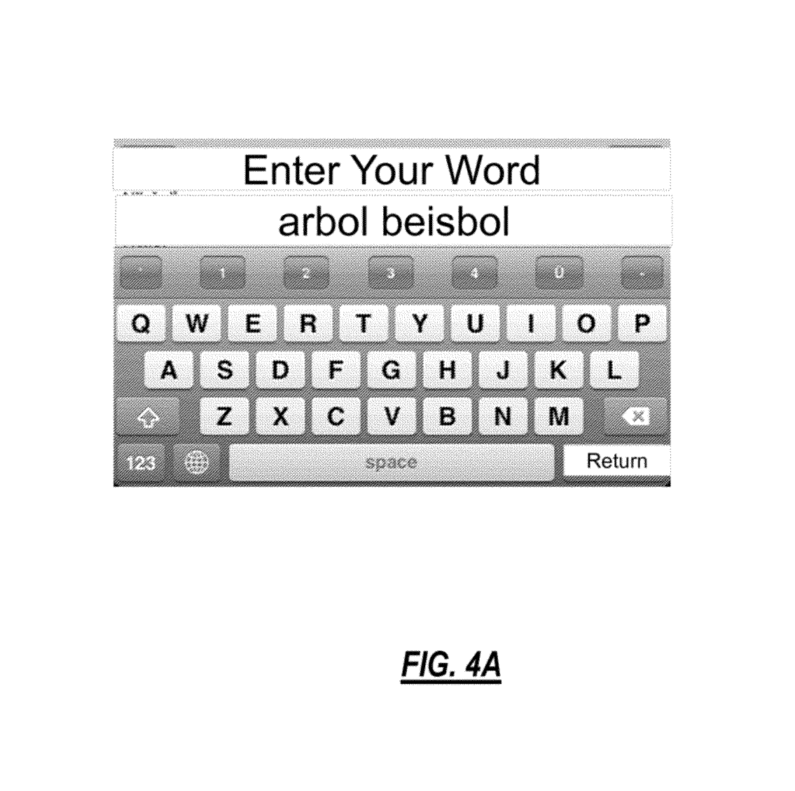

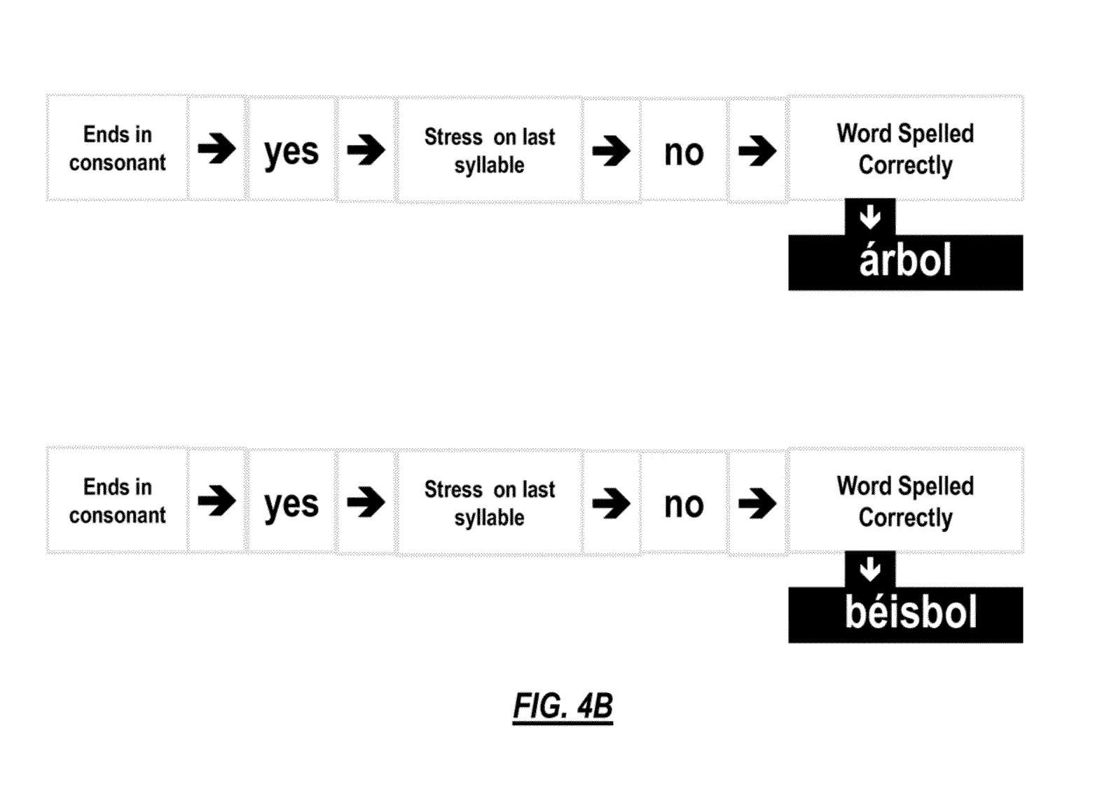

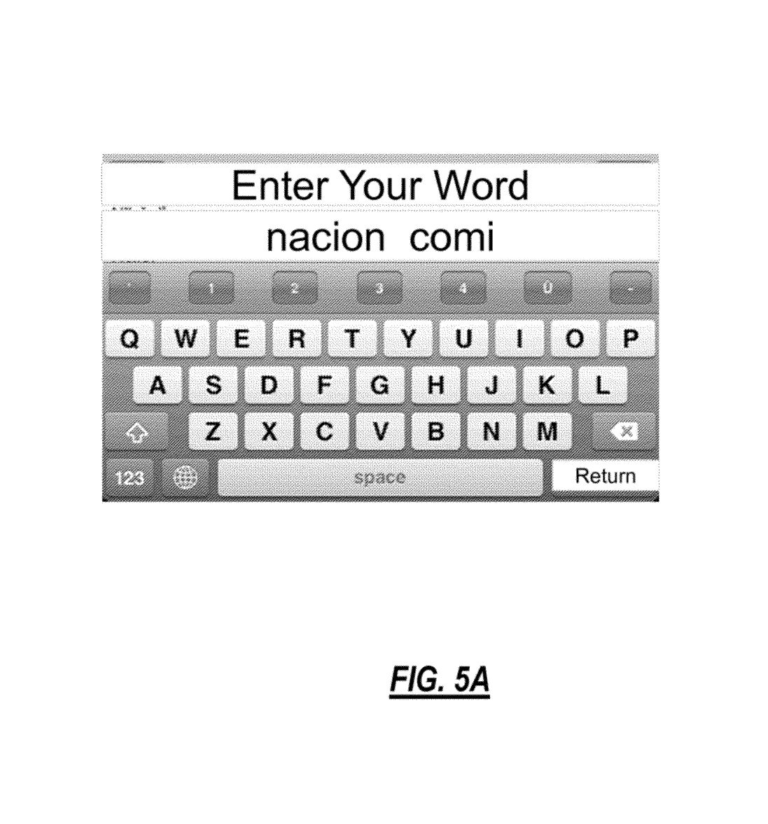

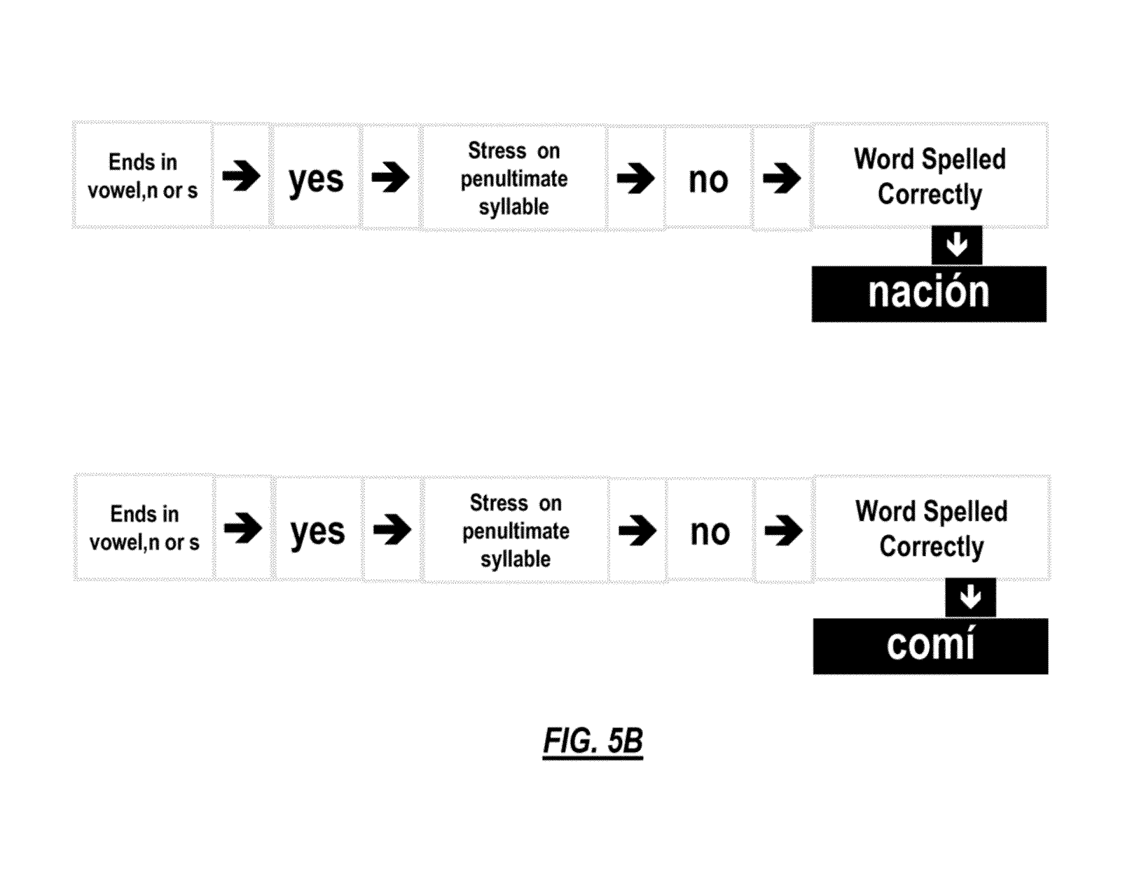

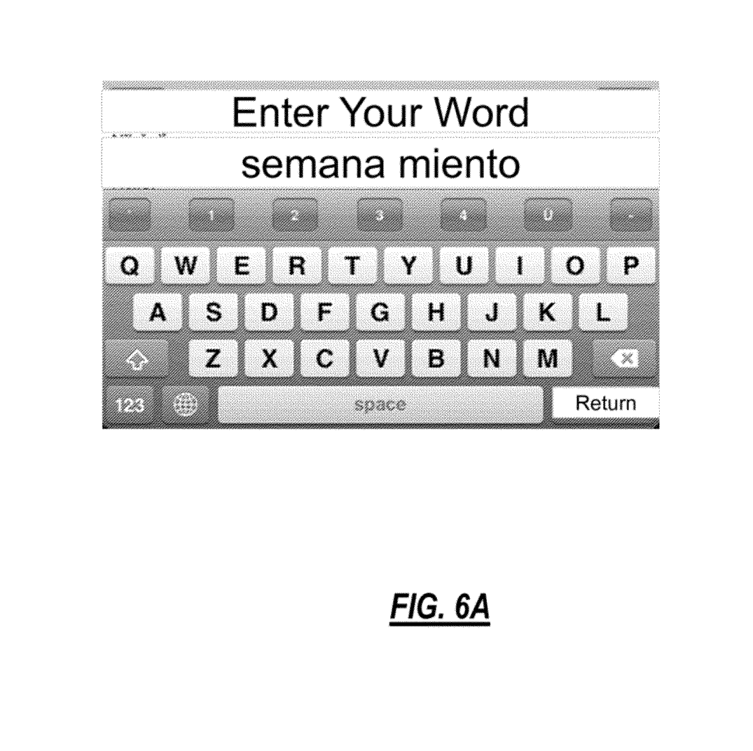

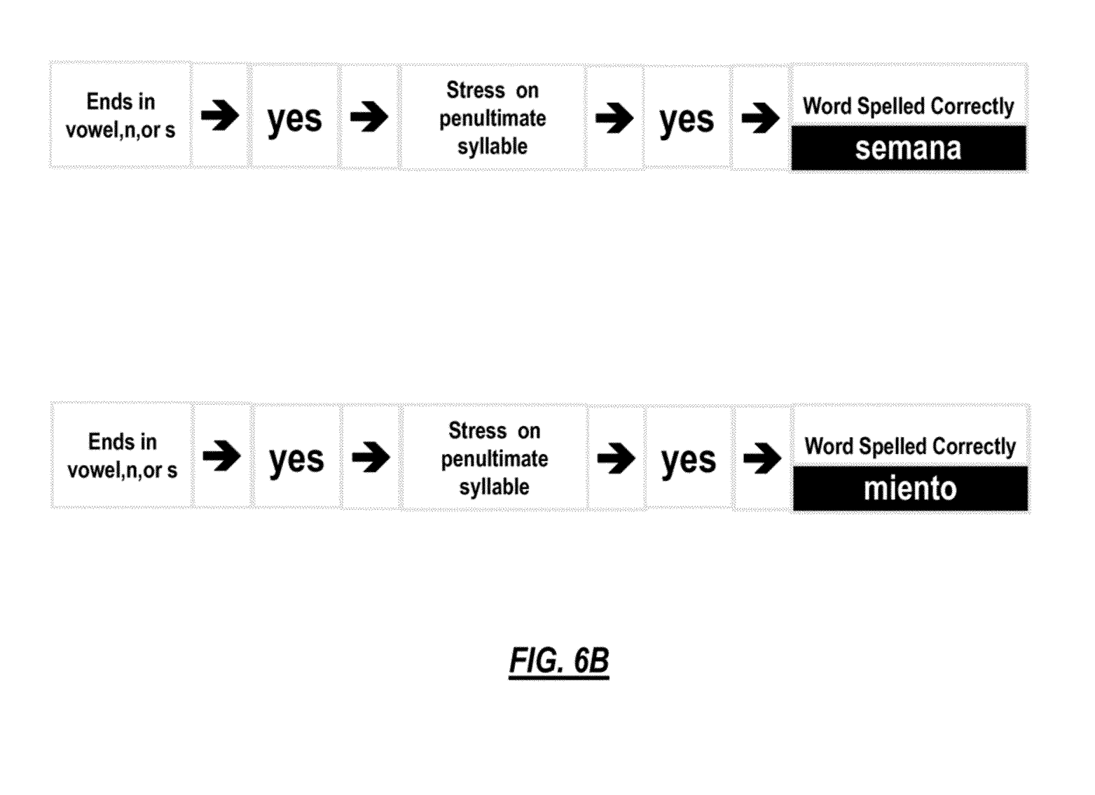

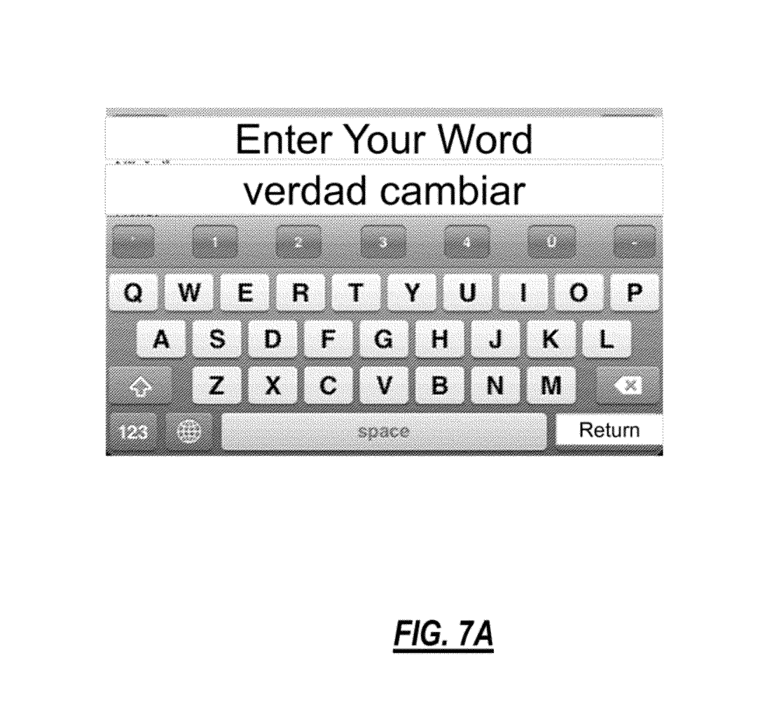

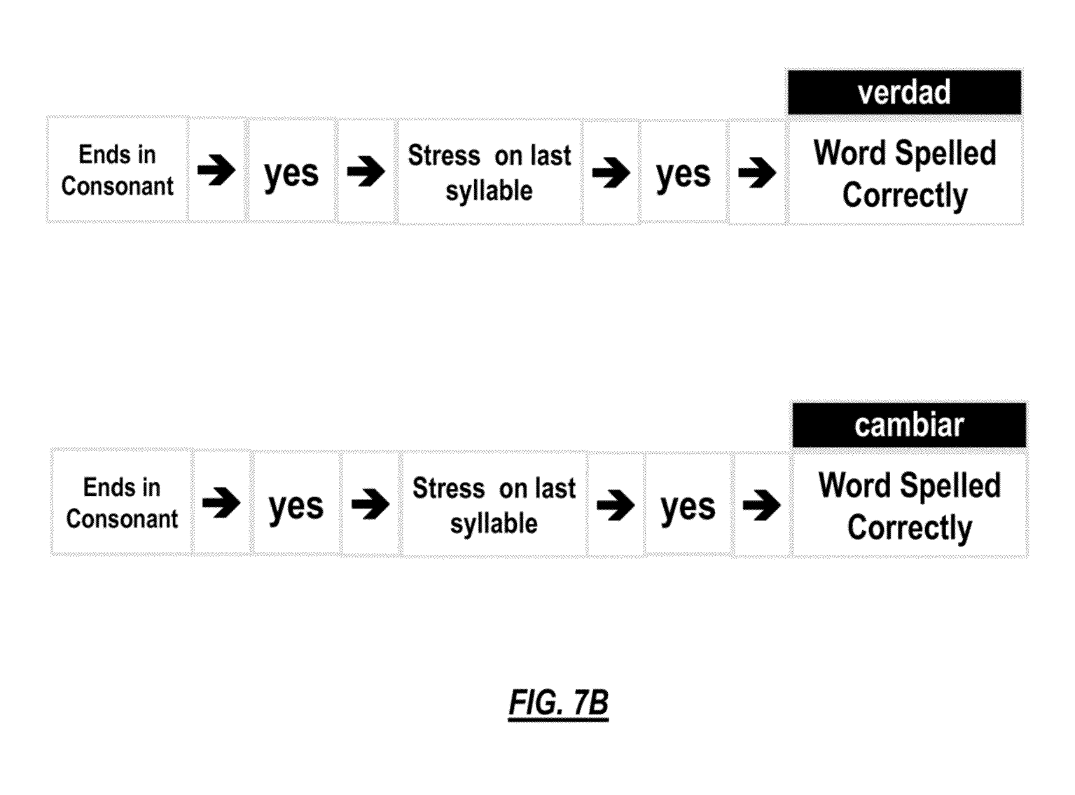

What is claimed is:

1. A method, comprising:
receiving a word in Spanish;
categorizing the word in one of four word sets comprising word set A, word set B, word set C, and word set D;
responsive to categorizing the word in the one of the four word sets, determining which syllable of the word is stressed; and
responsive to determining which syllable of the word is stressed, determining whether the word receives an accent mark and a proper placement of the accent mark.

2. The method of claim 1, wherein the method is implemented by a computer.

3. The method of claim 1, wherein the method is implemented in printed materials.

4. The method of claim 1, wherein the categorizing step comprises:
assigning the word to the word set A or the word set B when the word ends in a vowel, “n”, or “s;” and
assigning the word to the word set C or the word set D when the word ends in a consonant not including “n” or “s.”

5. The method of claim 4, wherein the determining which syllable of the word is stressed comprises:
when the word is in the word set A or the word set B, determining whether stress is on a penultimate syllable of the word; and
when the word is in the word set C or the word set D, determining whether the stress is on the last syllable.

6. The method of claim 4, further comprising:
when the word is in the word set A or the word set B, performing the steps of:
determining the word is in the word set A when the stress is on the penultimate syllable and placing no accent mark on the word; and
determining the word is in the word set B when the stress is not on the penultimate syllable and placing an accent mark on the word over a vowel of a stressed syllable; and
when the word is in the word set C or the word set D, performing the steps of:
determining the word is in the word set C when the stress is on the last syllable and placing no accent mark on the word; and
determining the word is in the word set D when the stress is not on the last syllable and placing an accent mark on the word over a vowel of stressed syllable.
